(19) United States
(12) Patent Application Publication
(10) Pub. No.: US 2006/0272137 A1
(43) Pub. Date: Dec. 7, 2006

(54) Locking loop

(76) Inventor: William J. Dandie, Caledon (CA)

Correspondence Address: VALENTINE A. COTTRILL, SUITE 1020 50 QUEEN STREET NORTH, KITCHENER, ON, N2H6M2, CA

(21) Appl. No.: 11/447,107

(22) Filed: Jun. 6, 2006

Related U.S. Application Data
(60) Provisional application No. 60/687,337, filed on Jun. 6, 2005.

(51) Int. Cl. A41F 1/00; G09F 23/00; A44B 11/25; A43C 11/00; A44B 1/04

(52) U.S. Cl. 24/616; 40/640

(57) ABSTRACT

A locking loop to be positioned on a member. The locking loop includes a first body segment having an inner end and an outer end, and a second body segment having an inner end and an outer end, the first and second body segments being adapted for assembly to form a central segment. The locking loop also includes an elongate element having a first end and a second end. The elongate element extends between the outer ends of the first and second body segments when the first and second body segments are located at the first and second ends respectively, so that the member is encircleable by the locking loop upon assembly of the central segment. Also, the locking loop includes two or more tools for engagement with the central segment to tighten an assembly of the first and second body segments, and to loosen the assembly thereof.

### FIELD OF THE INVENTION

This invention is related to a locking loop to be positioned on a member.

### BACKGROUND OF THE INVENTION

Many types of loop assemblies for positioning on a body member, such as bracelets and ankle bracelets, are known.

In general, known loop assemblies can include features of sentimental value, or features identifying a wearer as a member of a group. For example, “charm” bracelets are popular. The “charms” attached to such bracelets can indicate a wide variety of interests or preferences or affiliations.

However, known loop assemblies do not have a more tangible, or functional, indication of, for instance, an affiliation with one or more others, or a membership, or an interest which the wearer has.

There is a need for an innovative loop assembly with functional features identifying the wearer or the wearer's interests or affiliations in a predetermined manner.

### SUMMARY OF THE INVENTION

In its broad aspect, the invention provides a locking loop to be positioned on a member. The locking loop includes a first body segment having an inner end and an outer end, and a second body segment having an inner end and an outer end. The first and second body segments are adapted for assembly to form a central segment. The locking loop also includes an elongate element having a first end and a second end. The first and second body segments are respectively locatable adjacent to the first and second ends, and the elongate element extends between the outer ends of the first and second body segments when the first and second body segments are located at the first and second ends respectively. The member is encircleable by the locking loop upon assembly of the central segment. In addition, the locking loop also includes two or more tools for engagement with the central segment to tighten an assembly of the first and second body segments, and to loosen the assembly thereof.

In another aspect, the locking loop includes a threaded portion for threadable engagement with the first and second body segments for assembly of the first and second body segments to form the central segment.

In another of its aspects, the threaded portion is mountable adjacent to the first end of the elongate element. The threaded portion is removable from the elongate element, to permit detachment of the first body segment from the elongate element.

In yet another aspect, the invention additionally includes a sleeve portion secured to the elongate element adjacent to the first end for strengthening the elongate element. The sleeve portion is adapted to cooperate with the threadable portion to locate the threaded portion adjacent to the first end.

The locking loop also includes a plurality of beads slidably positionable on the elongate element, in another of its aspects.

In another of its aspects, the invention includes a method of varying a plurality of beads on an elongate element. Each bead is slidably positionable on the elongate element. The method includes, first, providing a locking loop having first and second body segments, each with respective inner and outer ends. The elongate element extends between the outer ends of the first and second body segments when the first and second body segments are located adjacent to the first and second ends of the elongate element respectively. The locking loop also includes a threaded portion for threadable engagement with the first and second body segments, for assembly of the first and second body segments to form a central segment. The threaded portion is mountable on a sleeve portion secured to the elongate element adjacent to the first end and removable therefrom to permit detachment of the first body segment from the elongate element.

Next, the method includes removing the threaded portion from the sleeve portion when the first and second body segments are disassembled.

Finally, the method includes moving the beads over the sleeve portion, to vary the beads positioned on the elongate element.

### BRIEF DESCRIPTION OF THE DRAWINGS

The invention will be better understood with reference to the attached drawings, in which:

FIG. 1 is an isometric view of an embodiment of a locking loop of the invention;

FIG. 2 is an isometric view of an embodiment of a tool of the invention, drawn at a larger scale;

FIG. 3 is an isometric view of an embodiment of a bead container of the invention, drawn at a larger scale;

FIG. 4 is an isometric view of an embodiment of a bead of the invention;

FIG. 5 is an isometric view of an alternative embodiment of a bead of the invention;

FIG. 6 is an isometric view of a portion of an embodiment of an elongate element of the invention showing a first end thereof and the bead of FIG. 4 positioned for movement thereover;

FIG. 7 is an isometric view of the portion of the elongate element of FIG. 6 with the bead slidably positioned thereon;

FIG. 8 is an isometric view of the portion of the elongate element of FIG. 7 with an embodiment of a first body segment of the invention positioned for movement onto the elongate element;

FIG. 9 is an isometric view of the portion of the elongate element of FIG. 8 with the first body segment located thereon;

FIG. 10 is an isometric view of the portion of the elongate element of FIG. 9 with an embodiment of a threaded portion of the invention positioned for mounting adjacent to the first end;

FIG. 11 is an isometric view of the portion of the elongate element of FIG. 10 showing the threaded portion mounted adjacent to the first end;

FIG. 12 is an isometric view of the portion of the elongate element of FIG. 11 showing the first body segment threadably engaged with a part of the threaded portion;

FIG. 13 is an isometric view of the portion of the elongate element of FIG. 12 with an embodiment of a second body segment of the invention located at a second end of the elongate element and positioned for assembly with the first body segment;

FIG. 14 is an isometric view of the first and second body segments of FIG. 13, assembled to form an embodiment of a central segment of the invention;

FIG. 15 is a cross-section of the central segment of FIG. 14;

FIG. 16 is an isometric view of the central segment of FIG. 14 with two tools engaged with the first and second body segments respectively;

FIG. 17 is an isometric view of an embodiment of the locking loop of the invention in an assembled state, with one bead slidably positioned on the elongate element;

FIG. 18 is an isometric view of the locking loop of FIG. 17 showing tools engaged with the first and second body segments respectively for loosening the assembly thereof;

FIG. 19 is an isometric view of the locking loop of FIG. 16 showing the first and second body segments, and the threaded portion;

FIG. 20 is an isometric view of a portion of the locking loop of FIG. 16 showing the first and second body segments separated;

FIG. 21 is an isometric view of a portion of the elongate element and the first end thereof, with the first body segment moved away from the first end to expose the threaded portion;

FIG. 22 is an isometric view of the portion of the elongate element of FIG. 20 showing the removal of the threaded portion;

FIG. 23 is an isometric view of the portion of the elongate portion of FIG. 20 showing the first body segment being detachable from the elongate element;

FIG. 24 is an isometric view of the portion of the elongate element of FIG. 20 showing the first body portion detached from the elongate element;

FIG. 25 is an isometric view of the portion of the elongate element of FIG. 20 showing the bead slidably positioned on the elongate element; and

FIG. 26 is an isometric view of the portion of the elongate element of FIG. 20 showing the bead removed from the elongate element.

### DETAILED DESCRIPTION

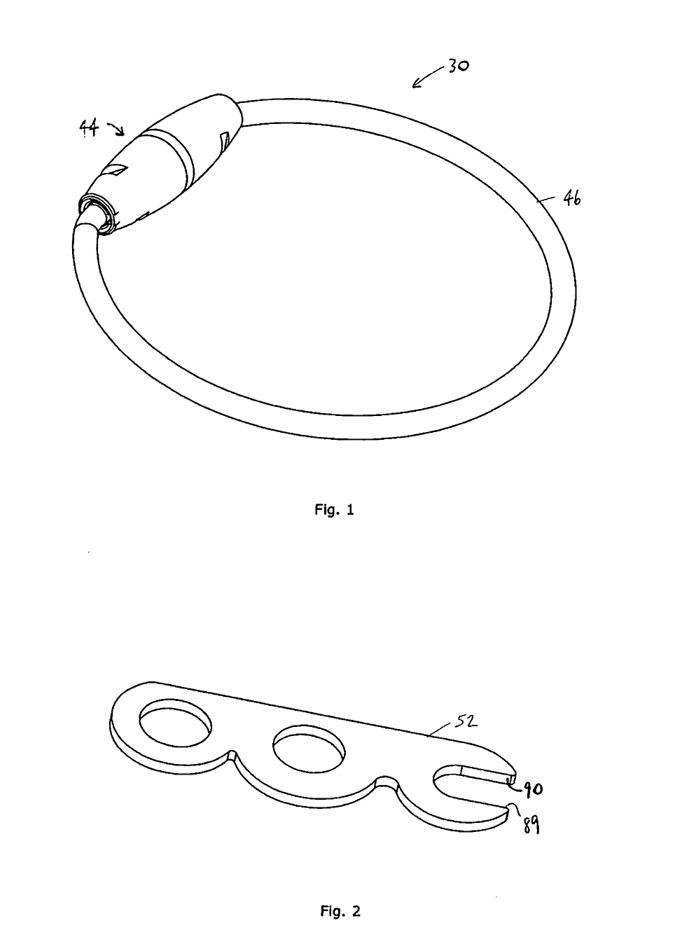

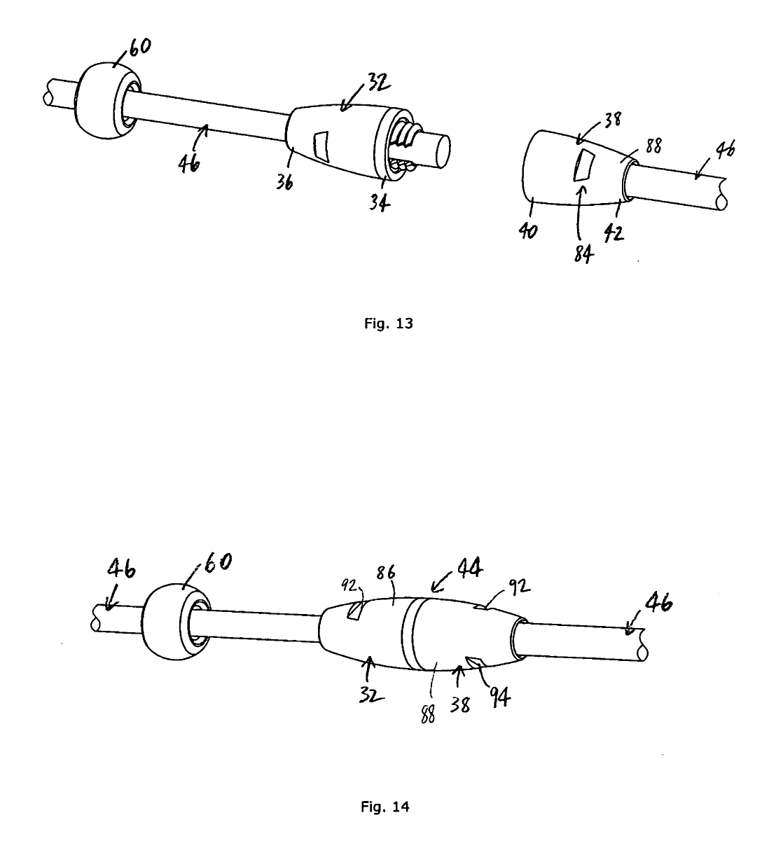

Reference is first made to FIGS. 1-16 to describe an embodiment of a locking loop indicated generally by the numeral 30 in accordance with the invention. The locking loop 30 is to be positioned on a member (not shown), such as an arm. In one embodiment, the locking loop 30 includes a first body segment 32 having an inner end 34 and an outer end 36 and a second body segment 38 having an inner end 40 and an outer end 42 (FIG. 13). The first and second body segments 32, 38 are adapted for assembly to form a central segment 44 (FIG. 1), as will be described.

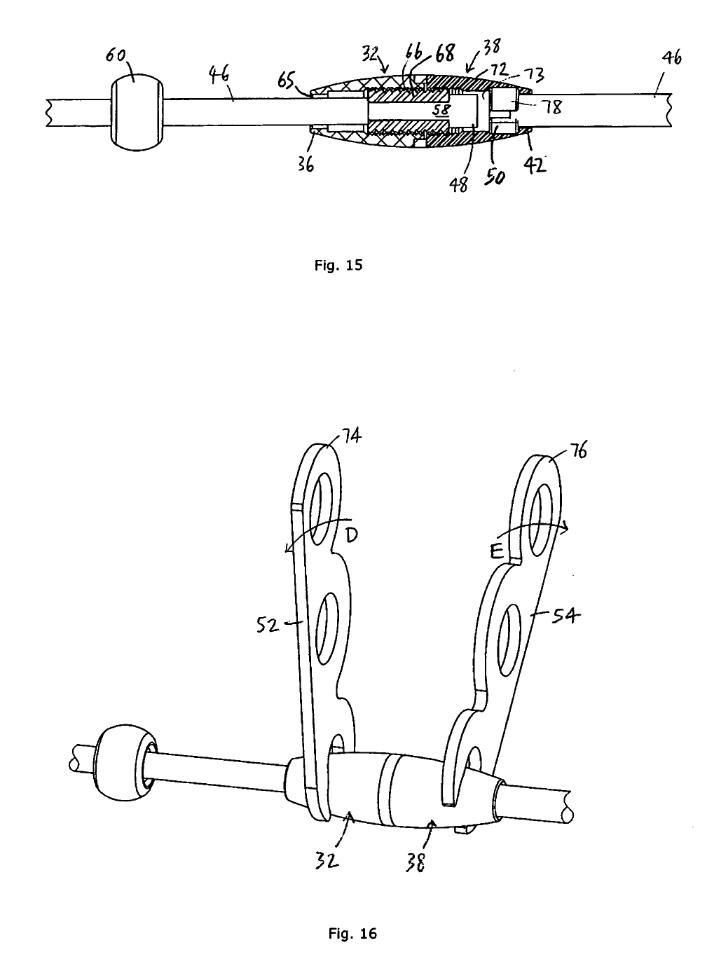

The locking loop 30 also includes an elongate element 46 with a first end 48 and a second end 50 (FIG. 15). As will also be described, the first and second body segments 32, 38 are respectively locatable adjacent to the first and second ends 48, 50. The elongate element 46 extends between the outer ends 36, 42 of the first and second body segments 32, 38 when the first and second body segments 32, 38 are located adjacent to the first and second ends 48, 50 respectively, as shown in FIG. 15. The member is encircleable by the locking loop 30 upon assembly of the central segment 44. In addition, the locking loop 30 preferably includes two or more tools 52, 54 (FIG. 16) for engagement with the body segments 32, 38 respectively to tighten an assembly of the first and second body segments 32, 38, and also to loosen the assembly thereof.

Preferably, the locking loop 30 includes a threaded portion 56 for threadable engagement with the first and second body segments 32, 38 for assembly of the first and second body segments 32, 38 to form the central segment 44. In one embodiment, the threaded portion 56 is mountable adjacent to the first end 48 of the elongate element 46. The threaded portion 56 preferably is removable from the elongate element 46, to permit detachment of the first body segment 32 from the elongate element 46, as will be described. Also, the locking loop 30 preferably includes a sleeve portion 58 secured to the elongate element 46 adjacent to (or on) the first end 48 for strengthening the elongate element 46. The sleeve portion 58 is adapted to cooperate with the threadable portion 56 to locate the threaded portion 56 adjacent to the first end 48. The locking loop 30 preferably also includes a number of beads 60 which are configured to be slidably positionable on the elongate element 46.

To simplify the drawings, only one bead is shown. However, it will be understood that the locking loop 30 preferably includes a plurality of beads 60. Preferably, the beads 60 are made of silicone plastic, but it will be understood that they may be made of any suitable material.

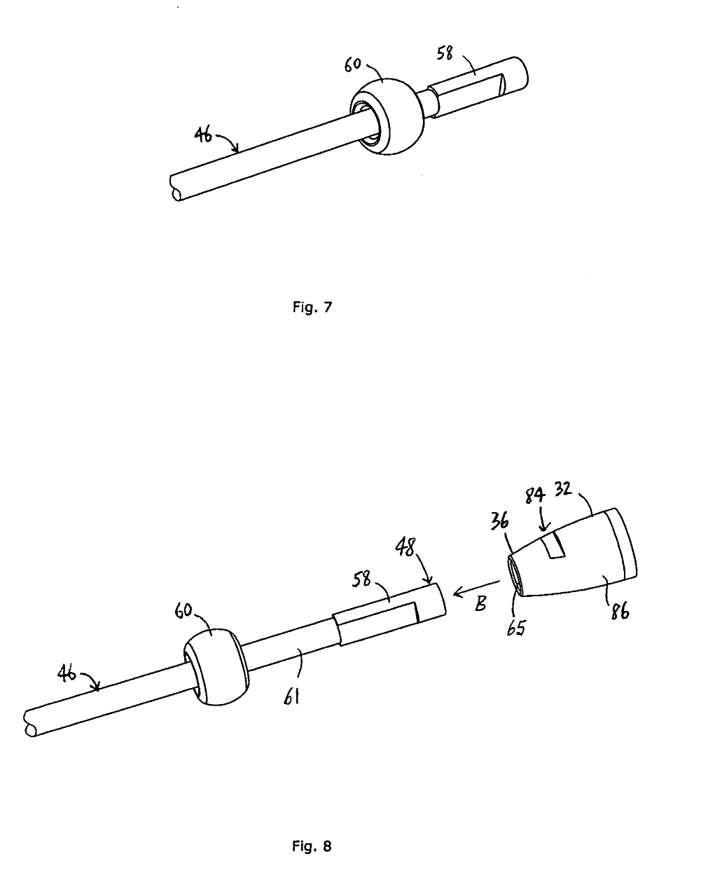

The multi-step process of adding the bead 60 so that it is slidably positioned on the elongate element 46 is shown in FIGS. 6-16, and will now be described. A portion 61 of the elongate element 46 is shown in FIG. 6. As can be seen in FIG. 6, the sleeve portion 58 is positioned on the elongate element 46 adjacent to the first end 48, and the bead 60 is positioned for movement over the sleeve portion 58 and the portion 61 in the direction of arrow “A”. FIG. 7 shows the bead 60 slidably positioned on the portion 61.

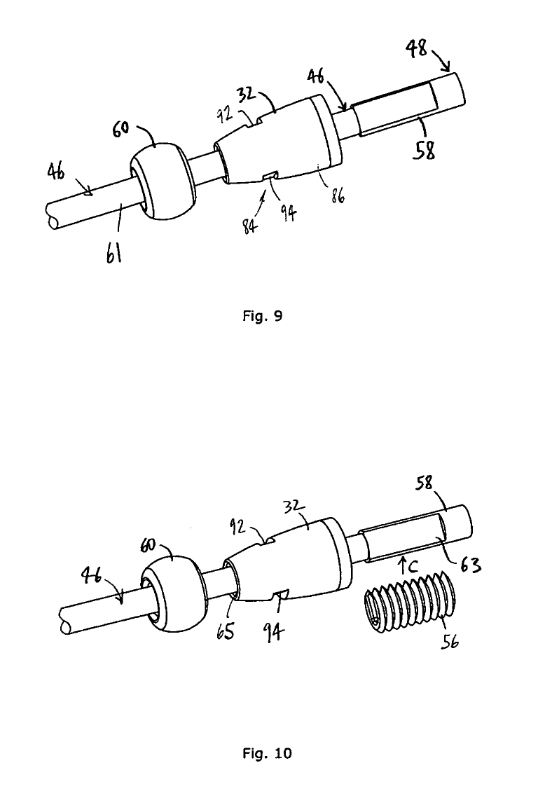

FIG. 8 shows the first body segment 32 positioned for location on the elongate element 46 adjacent to the first end 48, i.e., the segment 32 is positioned for movement in the direction of arrow “B”. In FIG. 9, the first body segment 32 is shown as being located on the elongate element 46. Preferably, the first body segment 32 is easily moved onto the portion 61.

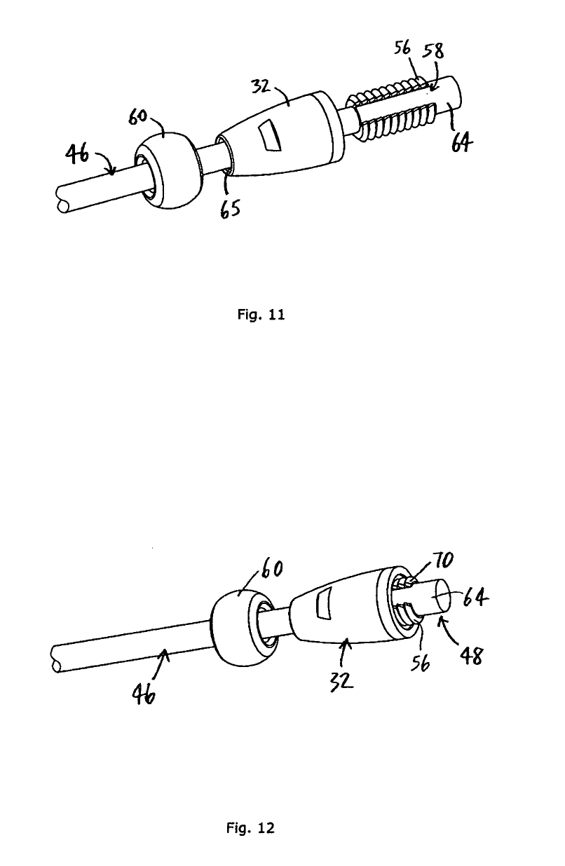

FIG. 10 shows the threaded portion 56 in position for mounting adjacent to the first end 48 of the elongate element 46. Specifically, the threaded portion 56 is to be mounted on the sleeve portion 58 by sliding the threaded portion 56 onto a flattened part 63 of the sleeve portion 58 (in the direction of arrow “C”). FIG. 11 shows the threaded portion 56 in position on the sleeve portion 58. A stop part 64 of the sleeve portion 58 is positioned adjacent to the flattened part 63 to maintain the threaded portion 56 in position on the flattened part 63 of the sleeve portion 58. As can be seen in FIGS. 8-11, the first body segment 32 includes an aperture 65 at its outer end 36 with a diameter substantially greater than the diameter of the stop 64 of the sleeve portion 58 and the diameter of the elongate element 46, so that the first body segment 32 can easily be moved over the sleeve portion 58 and onto the elongate element 46.

As shown in FIG. 11, the outer diameter of the threaded portion 58 preferably exceeds the diameter of the aperture 65, so that the first body segment 32 is maintained on the elongate element 46 by the threaded portion 56. The first body segment 32 includes a bore 66 (FIG. 15) extending from its inner end 34 towards the outer end 36, and the bore 66 preferably has a diameter substantially larger than the diameter of the aperture 65. Also, the bore 66 preferably is threaded for threadable engagement with the threaded portion 56.

Preferably, the first body segment 32 is turned onto the threaded portion 56 until a preselected part 68 (FIG. 15) of the threaded portion 56 is engaged with the bore 66 inside the first body segment 32. As can be seen in FIG. 12, at this stage of the process, an exposed part 70 of the threaded portion 56 is exposed, and available for engagement with a bore 72 (FIG. 15) of the second body segment 38. In FIG. 13, the second body segment 38 is shown located at the second end 50 and in position for threadable engagement with the exposed part 70 of the threaded portion 56. FIG. 14 shows the first and second body segments 32, 38 assembled to form the central segment 44. The assembly preferably is achieved by threadable engagement of the first and second body segments 32, 38 with the threaded portion 56. Specifically, the exposed part 70 of the threaded portion 56 is threadably engaged with the bore 72 of the second body segment 38.

As shown in FIG. 15, when the first and second body segments 32, 38 are assembled, a gap 73 is defined between the ends 48, 50. The gap 73 permits tightening of the assembly.

As can be seen in FIG. 15, the second body segment 38 preferably is held in a predetermined position at the second end 50 by a plug 78 which is securely attached to the elongate element 46 and also to the second body segment 38.

The tools 52, 54 engage one or more tool engagement portions 84 located on exterior surfaces 86, 88 of the first and second body segments 32, 38 (FIGS. 8-14). Preferably, the tools 52, 54 are substantially in the form of open-end wrenches. For simplicity of illustration, only tool 52 is shown in FIG. 2. It will be understood that tool 54 preferably is identical to tool 52 in all material aspects. As can be seen in FIG. 2, the tool 52 includes prongs 89, 90 which are substantially parallel and spaced apart from each other a predetermined distance.

The engagement portions 84 preferably are a pair of slots 92, 94 which are substantially parallel to each other and spaced apart a preselected distance such that the prongs 89, 90 are receivable in the slots 92, 94.

As can be seen in FIG. 16, after the first and second body segments 32, 38 are assembled to form the central segment 44, the tools 52, 54 are used to tighten the assembly of the first and second body segments 32, 38. The prongs 89, 90 of each of the tools 52, 54 are positioned in the slots 92, 94 on the first and second body segments 32, 38 respectively, so that the tools 52, 54 engage the first and second body segments 32, 38. Preferably, the tightening is effected by pivotal movement of ends 74, 76 of the tools 52, 54 respectively in opposite directions, as shown by arrows “D” and “E”. It is preferred that the assembly is sufficiently tightened that the assembly is “locked” (because the disassembly substantially cannot be done by hand)—i.e., the tools are needed in order to loosen the first and second body segments 32, 38 so that they can subsequently be loosened by hand. The assembled locking loop 30, with the bead 60 slidably positioned on the elongate element 46, is shown in FIG. 17.

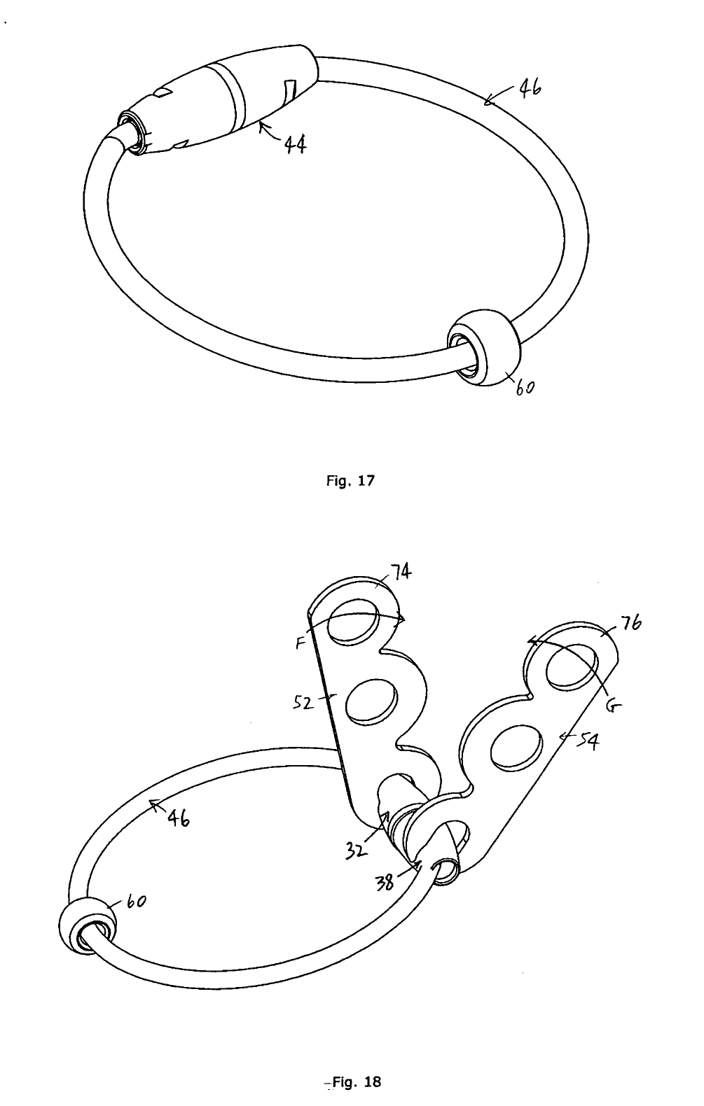

The process of removing the bead from the elongate element 46 is shown in FIGS. 18-26.

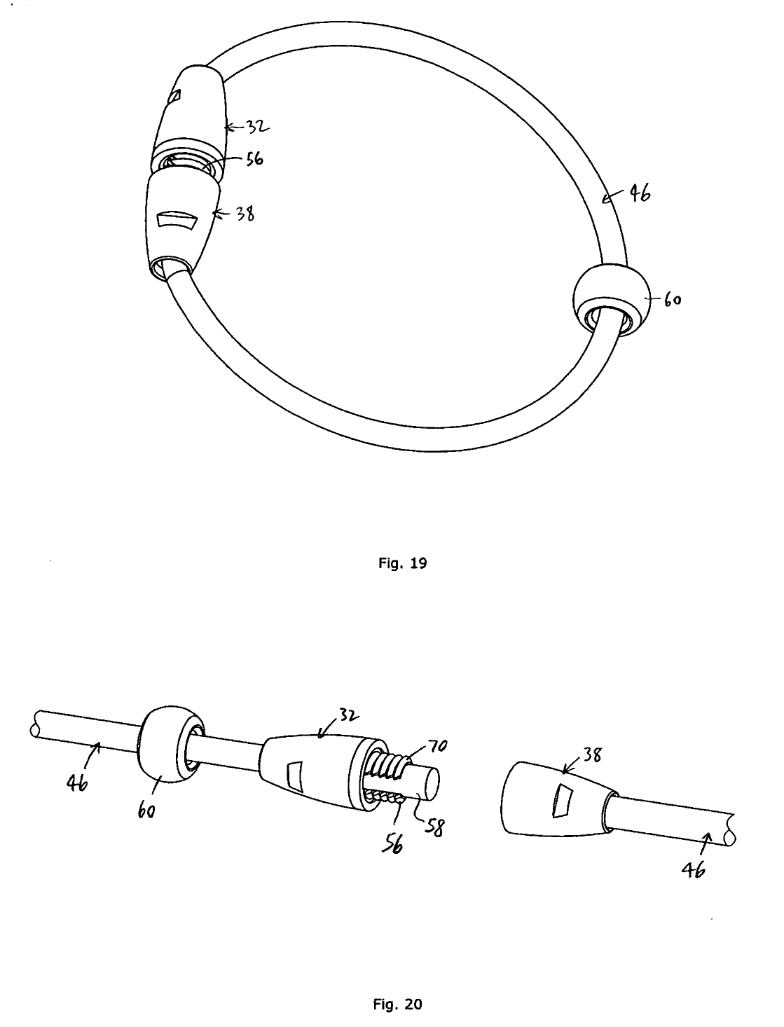

The process begins with engagement of the tools 52, 54 to loosen the assembly of the first and second body segments 32, 38. Preferably, the loosening is effected by pivotal movement of the ends 74, 76, of the tools 52, 54 respectively in opposite directions, as shown by arrows “F” and “G” in FIG. 18. Once the assembly has been sufficiently loosened, the first and second body segments 32, 38 can be unscrewed by hand (FIG. 19). As can be seen in FIG. 20, the second body segment 38 is then removed from the exposed part 70 of the threaded portion 56.

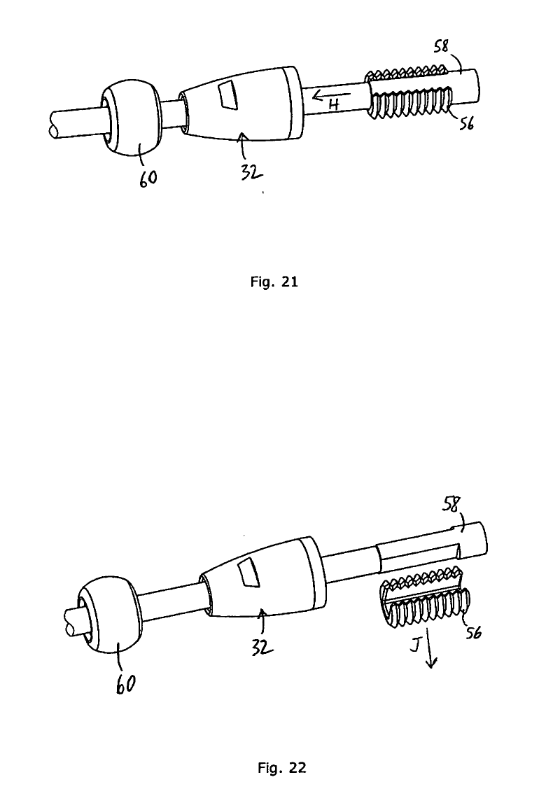

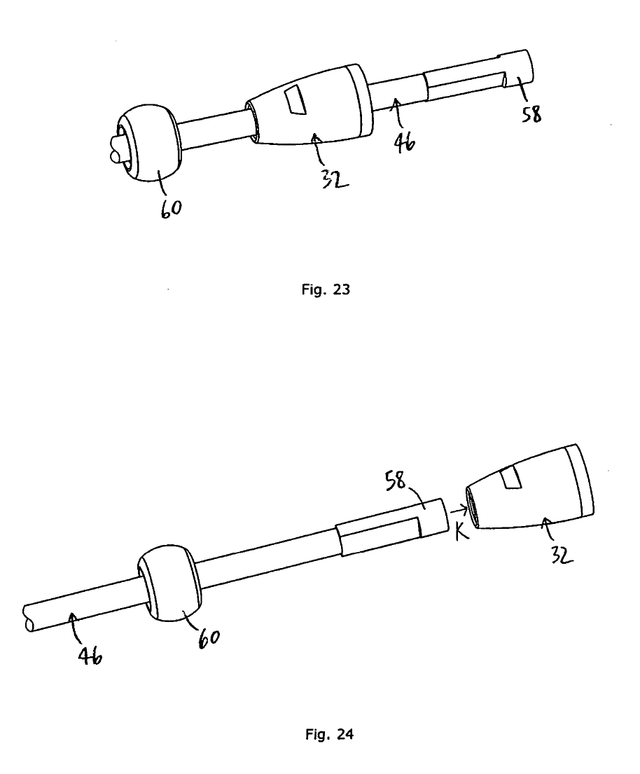

Next, the first body segment 32 is removed from the preselected part 68 of the threaded portion 56. The first body segment 32 preferably is moved along the elongate element 46 in the direction shown by arrow “H” in FIG. 21, to permit the threaded portion 56 to be accessed. As can be seen in FIG. 22, the threaded portion 56 is then removed from the sleeve portion 58 by pulling the threaded portion 56 in the direction shown by arrow “J”. As can be seen in FIGS. 23 and 24, the first body segment 32 is then moved in the direction shown by arrow “K” (FIG. 23), to remove the first body segment 32 from the elongate element 46.

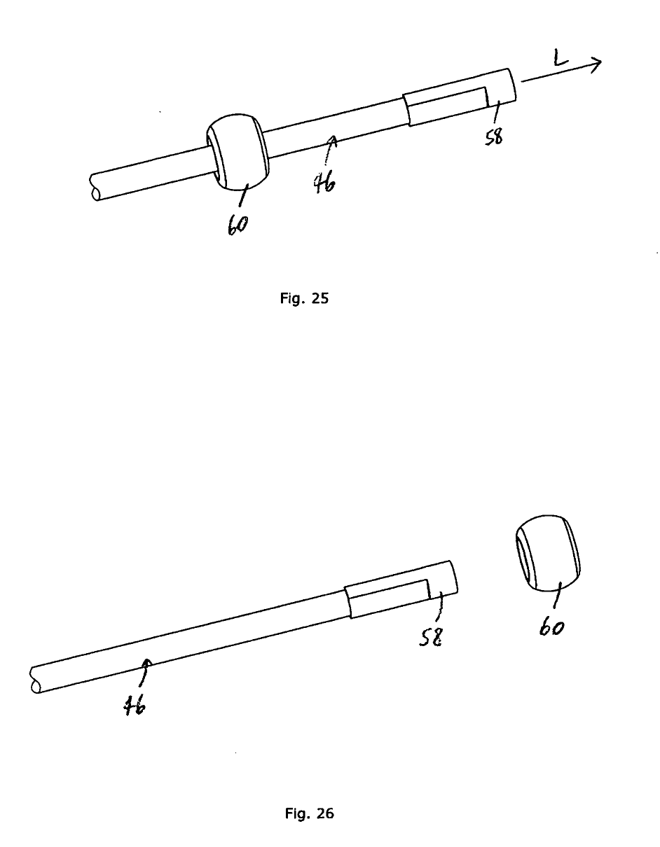

The removal of the bead 60 is shown in FIGS. 25 and 26. The bead 60 is moved in the direction shown by arrow “L” in FIG. 25.

In use, once the first and second body segments 32, 38 are ready for assembly (i.e., as shown in FIG. 13), a wearer (not shown) places the elongate element 46 around the wearer's member (e.g., a wrist), and then assembles the first and second body segments 32, 38. The wearer and a second party (not shown) then manipulate the tools 52, 54 respectively for engagement with the first body segment 32 and the second body segment 38 respectively, to tighten the assembly.

As noted above, the assembly preferably is sufficiently tightened that it is, in effect, “locked”—i.e., the assembly substantially is not loosenable by hand. Because of this, the tools 52, 54 are engaged in the first step of the removal process.

When the locking loop 30 is to be removed, then the wearer and the second party manipulate the tools 52, 54 respectively to loosen the assembly of the first and second body segments 32, 38, as shown in FIG. 18. As described above, after the assembly is sufficiently loosened, the first and second body segments 32, 38 are unscrewed (from the threaded portion 56) by hand, until they can be separated. Also, as described above, the first body segment 32 is removable from the elongate element 46, and after such removal, beads 60 can be added or removed (i.e., varied).

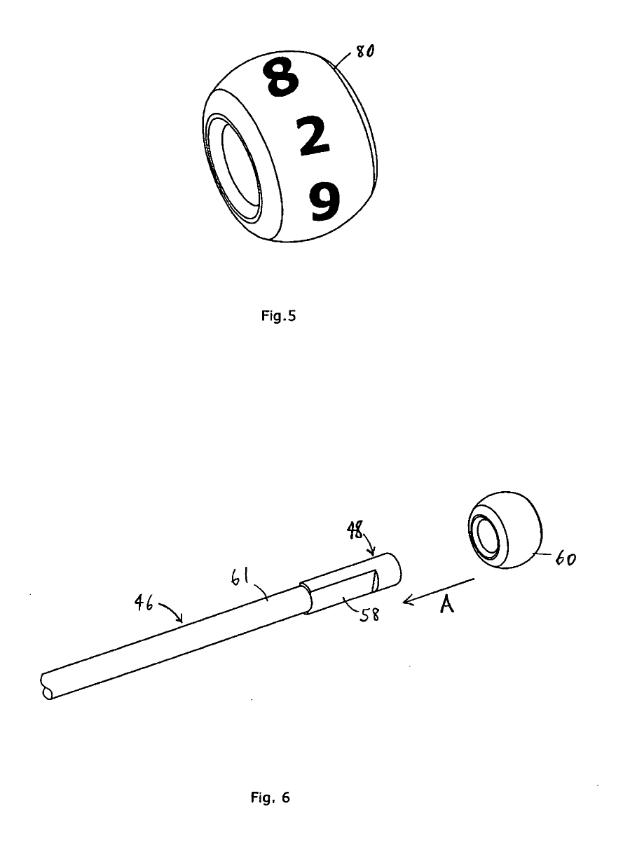

In another embodiment, one or more beads 80 (FIG. 5) have identification information thereon which can be used to identify the wearer.

The components of the locking loop 30 may be constructed of any suitable materials. However, the elongate element 46 is preferably made of a durable and flexible plastic, such as a silicone plastic. The first and second body segments 32, 38 are preferably made of any suitable metal, and provided with an appropriate exterior finish. Preferably, the body segments 32, 38 are made of aluminium.

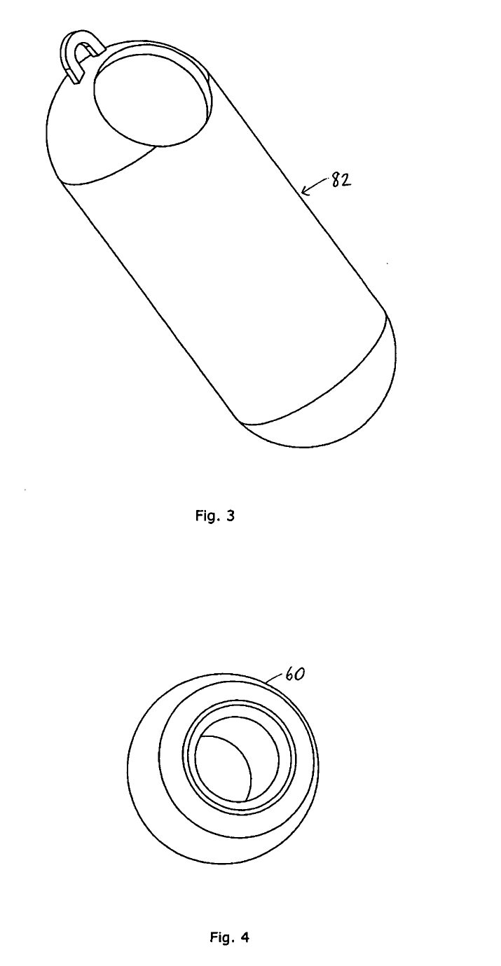

The locking loop 30 preferably also includes a container 82 (FIG. 3) in which beads 60, 80 are conveniently stored.

It will be understood that the tools held by the wearer and the second party need not necessarily be substantially identical—i.e., the two tools could be keyed differently. However, for reasons of cost of manufacturing and also convenience, it is preferred that the two tools be substantially the same.

Any element in a claim that does not explicitly state “means for” performing a specified function, or “step for” performing a specific function, is not to be interpreted as a “means” or “step” clause as specified in 35 U.S.C. §112, paragraph 6.

It will be evident to those skilled in the art that the invention can take many forms, and that such forms are within the scope of the invention as claimed. Therefore, the spirit and scope of the appended claims should not be limited to the description of the preferred versions contained herein.

I claim:

1. A locking loop to be positioned on a member, the locking loop comprising:
a first body segment having an inner end and an outer end;
a second body segment having an inner end and an outer end, the first and second body segments being adapted for assembly to form a central segment;
an elongate element having a first end and a second end, the first and second body segments being respectively locatable adjacent to the first and second ends, the elongate element extending between the outer ends of the first and second body segments when the first and second body segments are located at the first and second ends respectively such that the member is encircleable by the locking loop upon assembly of the central segment; and
at least two tools for engagement with the first and second body segments respectively to tighten an assembly of the first and second body segments, and to loosen the assembly thereof.

2. A locking loop according to claim 1 additionally comprising a threaded portion for threadable engagement with the first and second body segments for assembly of the first and second body segments to form the central segment.

3. A locking loop according to claim 2 in which the threaded portion is mountable adjacent to the first end of the elongate element, said threaded portion being removable therefrom to permit detachment of the first body segment from the elongate element.

4. A locking loop according to claim 3 additionally comprising a sleeve portion secured to the elongate element adjacent to the first end for strengthening the elongate element, the sleeve portion being adapted to cooperate with the threadable portion to locate the threaded portion adjacent to the first end.

5. A locking loop according to claim 4 additionally comprising a plurality of beads slidably positionable on the elongate element.

6. A locking loop according to claim 5 in which each said bead is adapted for coaxially receiving the first end and the sleeve portion to position each said bead on the elongate element.

7. A locking loop according to claim 5 in which at least one of said beads comprises preselected identification information.

8. A locking loop according to claim 1 additionally including at least one bead slidably positionable on the elongate element between the outer ends of the first and second body segments.

9. A locking loop according to claim 8 in which said at least one bead comprises preselected identification information.

10. A locking loop according to claim 1 in which the elongate element is adjustable in length such that the elongate element fits around the member with a preselected tolerance.

11. A locking loop according to claim 1 in which each of the first and second segments respectively comprises at least one tool engagement portion adapted for engagement with one of said at least two tools.

12. A locking loop according to claim 11 in which said tool engagement portions are located on respective exterior surfaces of the first and second body segments.

13. A locking loop according to claim 11 in which said at least two tools comprise open-end wrenches.

14. A locking loop according to claim 11 in which said engagement portions comprise slots into which prongs of said wrenches are receivable.

15. A method of varying a plurality of beads on an elongate element, each said bead being slidably positionable on the elongate element, the method comprising:
(a) providing a locking loop comprising:
a first body segment having an inner end and an outer end;
a second body segment having an inner end and an outer end;
the elongate element extending between the outer ends of the first and second body segments when the first and second body segments are located adjacent to the first and second ends of the elongate element respectively;
a threaded portion for threadable engagement with the first and second body segments for assembly of the first and second body segments to form a central segment;
the threaded portion being mountable on a sleeve portion secured to the elongate element adjacent to the first end and removable therefrom to permit detachment of the first body segment from the elongate element;
(b) removing the threaded portion from the sleeve portion when the first and second body segments are disassembled; and
(c) moving said beads over the sleeve portion, to vary said beads positioned on the elongate element.
